(19) United States
(12) Patent Application Publication
(10) Pub. No.: US 2022/0380046 A1
(43) Pub. Date: Dec. 1, 2022

(54) Amphibious Cargo Carrying UAV

(71) Applicant: Shanghai Autoflight Co., Ltd., Kunshan City (CN)

(72) Inventor: Yu Tian, Hong Kong SAR (CN)

(21) Appl. No.: 17/827,383

(22) Filed: May 27, 2022

(30) Foreign Application Priority Data
May 27, 2021 (CN) 202121159995.8

(51) Int. Cl. B64C 39/02; B64C 35/00

(52) U.S. Cl. CPC B64C 39/024; B64C 35/008; B64C 2201/128; B64C 2201/021; B64C 2201/104

(57) ABSTRACT

An amphibious cargo carrying unmanned aerial vehicle (UAV) having a fuselage, two wings and two frames, in which a cargo hold is arranged at the lower end of the fuselage, the cargo hold is provided with a cargo chamber for cargo carrying, and the cargo hold can touch the water surface at the same time. When taking off or landing on the water surface, the hollow structure of the cargo chamber can provide additional buoyancy. The two wings are symmetrically arranged on both sides of the fuselage, the two frames are correspondingly arranged on the two wings, and the buoyancy parts can be detachably arranged on the two frames to provide buoyancy.

### TECHNICAL FIELD

The application relates to the technical field of aircraft, in particular to an amphibious cargo carrying UAV.

### BACKGROUND ART

With the development of the domestic UAV market, from the initial application of UAV in the military field to the consumer field, the UAV market is becoming more and more popular, and the recognition and demand of ordinary people for UAV are also gradually rising. Due to its good mobility and simple use, UAV has been widely used in various industries such as police, agriculture, geology, electric power, rescue and disaster relief and video shooting. In particular, the amphibious UAV can be used both on water and on land, but the amphibious UAV in the prior art uses a pontoon to provide buoyancy. Small buoyancy results in light load, making it not suitable for the transportation of heavy goods.

### SUMMARY OF THE APPLICATION

The purpose of the application is to provide an amphibious cargo carrying UAV to solve the problem that the amphibious UAV in the prior art only uses a pontoon to provide buoyancy, and small buoyancy results in light load, making it not suitable for the transportation of heavy goods.

To achieve this purpose, the application adopts the following technical solution:

An amphibious cargo carrying UAV, comprising:

A fuselage, of which the lower end is provided with a cargo hold, which is provided with a cargo chamber and can touch the water surface to provide buoyancy for the fuselage;

Two wings, which are symmetrically arranged on both sides of the fuselage;

Two frames, which are correspondingly arranged on the two wings, and are detachably arranged with buoyancy parts.

The frame has a first end and a second end, the buoyancy parts include a first buoyancy part, which is arranged at the first end of the frame, and a second buoyancy part, which is arranged at the second end of the frame.

The first end of the frame is provided with a landing gear, and the first buoyancy part is arranged on the landing gear.

The first buoyancy part is provided with a first socket, and the landing gear is inserted into the first socket.

The second end of the frame is provided with a vertical tail, and the second buoyancy part is arranged on the vertical tail.

The second buoyant part is provided with a second socket, and the vertical tail is inserted into the second socket.

The first buoyant part and the second buoyant part are of hollow structure.

The cargo hold is provided with a buckle, and the cargo hold connects to the fuselage through the detachable buckle.

The fuselage is provided with a plurality of rotors.

The fuselage is provided with a speed sensor.

The beneficial effects of the application are as follows: The application provides an amphibious cargo carrying UAV, in which a cargo hold is arranged at the lower end of a fuselage, and the cargo hold is provided with a cargo chamber for cargo carrying and can touch the water surface at the same time. When taking off or landing on the water surface, the hollow structure of the cargo chamber can provide additional buoyancy. The buoyancy parts can be detachably arranged on the two frames to provide buoyancy. When used on land, the buoyancy parts can be removed. Compared with the amphibious UAV taking off and landing on the water only through the pontoon in the prior art, the amphibious cargo UAV provided by the application provides additional buoyancy through the hollow structure of the cargo hold, resulting in more stable take-off and landing on the water surface and allowing the cargo chamber to transport more goods at one time.

### BRIEF DESCRIPTION OF THE FIGURES

FIG. 1 is an axonometric view of the overall structure of an amphibious cargo carrying

UAV of the application.

Wherein,

1. Fuselage; 11. Cargo hold;

2. Wing;

3. Frame; 31. First end; 32. Second end;

4. Buoyancy parts; 41. First buoyancy part; 42. Second buoyancy part;

5. Landing gear;

6. Vertical tail;

7. Rotor.

### DETAILED DESCRIPTION

The technical solution of the application is further described below in combination with the figure and the embodiment. It can be understood that the preferred embodiments described here are only used to explain the application, rather than to limit the application. In addition, it should be noted that in order to facilitate description, only some parts related to the application are shown in the figure, not all.

In the description of the application, it should be noted that unless otherwise specified and limited, the terms, “installation”, “connect” and “connection” should be understood in a broad sense. For example, it can be fixedly connected, or detachably connected. It can be mechanical connection or electrical connection. It can be connected directly or indirectly through an intermediate medium, and it can be the connection between the two components. For those skilled in the art, the specific meaning of the above terms in the application can be understood in specific circumstances.

In the application, unless otherwise clearly specified and limited, the first feature “on” or “under” the second feature may include the direct contact between the first and second features, or the contact between the first and second features that is not direct contact, but through another feature between them. Moreover, the first feature “on”, “over”, and “above” the second feature may include the first feature directly above and obliquely above the second feature, or only indicates that the horizontal height of the first feature is higher than the second feature. The first feature “under”, “below” and “beneath” the second feature, may include the first feature directly below and obliquely below the second feature, or only indicate that the horizontal height of the first feature is smaller than that of the second feature.

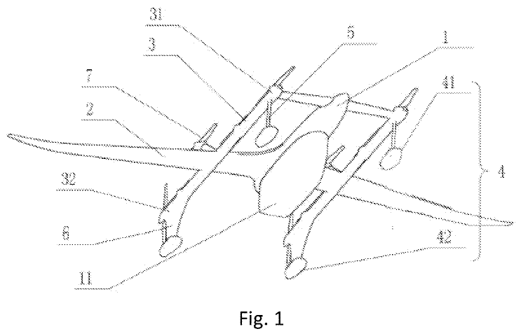

As shown in FIG. 1, this embodiment provides an amphibious cargo carrying UAV, which comprises a fuselage 1, two wings 2 and two frames 3. A cargo hold is arranged at the lower end of the fuselage 1 and has a cargo chamber for carrying cargo. The cargo hold 11 can touch the water surface. When taking off or landing on the water surface, the hollow structure of the cargo chamber can provide additional buoyancy. The two wings 2 are symmetrically arranged on both sides of the fuselage 1, the two frames 3 are correspondingly arranged on the two wings 2, and the buoyancy parts 4 are detachably arranged on the two frames 3 to provide buoyancy. Compared with the amphibious UAV taking off and landing on the water only through the buoyancy parts 4 in the prior art, the amphibious cargo carrying UAV provided in this embodiment provides additional buoyancy through the hollow structure of the cargo hold 11, resulting in more stable take-off and landing on the water surface. At the same time, the cargo hold is provided with a cargo chamber, allowing it to transport more goods at one time.

The frame 3 has a first end 31 and a second end 32. The buoyancy parts 4 includes a first buoyancy part 41 and a second buoyancy part 42. The first buoyancy part 41 is arranged at the first end 31 of the frame 3, the second buoyancy part 42 is arranged at the second end 32 of the frame 3, and two first buoyancy parts 41 and two second buoyancy parts 42 are symmetrically arranged on both sides of the fuselage 1 respectively, so that the amphibious cargo carrying UAV can take off and land on the water surface more smoothly. Further, the first end 31 of the frame 3 is provided with a landing gear 5, the first buoyancy part 41 is provided with a first socket, the landing gear 5 is inserted into the first socket, and the landing gear 5 is rotatably connected to the frame 3. When flying in the air, the landing gear 5 and the first buoyancy part 41 can be folded and retracted to reduce the air resistance during flight. The landing gear 5 is inserted into the first buoyancy part 41, and when applied to the take-off and landing scenario on land, the first buoyancy member 41 can be easily and quickly removed.

The second end 32 of the frame 3 is provided with a vertical tails 6, and two vertical tails 6 and two landing gears 5 are symmetrically distributed respectively, so that the amphibious cargo carrying UAV can take off and land on the water surface more stably. The second buoyancy part 42 is provided with a second socket, and the vertical tail 6 is inserted into the second socket, so that the second buoyancy part 42 can be easily and quickly removed when applied to the take-off and landing scenario on the land. The first buoyant part 41 and the second buoyant part 42 are of hollow structure. In this embodiment, the first buoyant part 41 and the second buoyant part 42 are both pontoons. In other embodiments, the first buoyant part 41 and the second buoyant part 42 may also be foam with large buoyancy, which is not too limited here. The cargo hold 11 is provided with a buckle, through which the cargo hold 11 connects to the fuselage 1 through the detachable buckle. In case of great cargo volume, the cargo hold 11 may be mounted. In case of low cargo volume or for investigation purpose, the cargo hold 11 may be removed from the fuselage 1 to reduce the weight of the fuselage 1 and result in more flexible flight. The fuselage 1 is provided with a plurality of rotors 7, which are symmetrically arranged on both sides of the fuselage 1 to ensure smooth takeoff and landing. The fuselage 1 is provided with a speed sensor, which can feed back the speed of the amphibious cargo UAV in real time. Obviously, the above embodiments of the application are only for the purpose of clarifying the application, but not for the purpose of limiting the embodiments of the application. For those skilled in the art, other changes or alterations in different forms may be made on the basis of the above description. It is unnecessary and impossible to enumerate all the embodiments here. Any modification, equivalent replacement and improvement made based on the spirit and principles of the application shall fall within the breadth and scope of the claims of the application.

1. An amphibious cargo carrying UAV (unmanned aerial vehicle), which is characterized by comprising:
a fuselage (1), a cargo hold (11) is arranged at the lower end of the fuselage (1), the cargo hold (11) is provided with a cargo chamber, and the cargo hold (11) can touch the water surface to provide buoyancy for the fuselage (1);
two wings (2), which are symmetrically arranged on both sides of the fuselage (1);
two frames (3), which are correspondingly arranged on the two wings, and can be detachably arranged with buoyancy parts (4).

2. The amphibious cargo carrying UAV according to claim 1, which is characterized in that the frame (3) has a first end (31) and a second end (32), the buoyancy parts (4) include a first buoyancy part (41) and a second buoyancy part (42), and the first buoyancy part (41) is arranged at the first end (31) of the frame (3), and the second buoyancy part (42) is arranged at the second end (32) of the frame (3).

3. The amphibious cargo carrying UAV according to claim 2, which is characterized in that the first end (31) of the frame (3) is provided with a landing gear (5), and the first buoyancy part (41) is arranged on the landing gear (5).

4. The amphibious cargo carrying UAV according to claim 3, which is characterized in that the first buoyancy part (41) is provided with a first socket, and the landing gear (5) is inserted into the first socket.

5. The amphibious cargo carrying UAV according to claim 2, which is characterized in that the second end (32) of the frame (3) is provided with a vertical tail (6), and the second buoyancy part (42) is arranged on the vertical tail (6).

6. The amphibious cargo carrying UAV according to claim 5, which is characterized in that the second buoyancy part (42) is provided with a second socket, and the vertical tail (6) is inserted into the second socket.

7. The amphibious cargo carrying UAV according to claim 2, which is characterized in that the first buoyancy part (41) and the second buoyancy part (42) are of hollow structure.

8. The amphibious cargo carrying UAV according to claim 1, which is characterized in that a buckle is arranged on the cargo hold (11), and the cargo hold (11) connects to the fuselage (1) through the detachable buckle.

9. The amphibious cargo carrying UAV according to claim 1, which is characterized in that a plurality of rotors (7) are arranged on the fuselage (1).

10. The amphibious cargo carrying UAV according to claim 1, which is characterized in that a speed sensor is arranged on the fuselage (1).
